(19) United States
(12) Patent Application Publication
(10) Pub. No.: US 2018/0225411 A1
(43) Pub. Date: Aug. 9, 2018

(54) METHODS FOR PREDICTION OF BINDING SITE STRUCTURE IN PROTEINS AND/OR IDENTIFICATION OF LIGAND POSES

(71) Applicant: CALIFORNIA INSTITUTE OF TECHNOLOGY, Pasadena, CA (US)

(72) Inventors: William A. GODDARD, III, PASADENA, CA (US); Adam R. GRIFFITH, OAK RIDGE, TN (US); Ravinder ABROL, PASADENA, CA (US); Ismet Caglar TANRIKULU, PASADENA, CA (US)

(21) Appl. No.: 15/934,791

(22) Filed: Mar. 23, 2018

Related U.S. Application Data
(63) Continuation of application No. 12/944,692, filed on Nov. 11, 2010, now abandoned.
(60) Provisional application No. 61/260,295, filed on Nov. 11, 2009.

(51) Int. Cl. G06F 19/16

(52) U.S. Cl. CPC G06F 19/16

(57) ABSTRACT

A method for modification and/or evaluation of ligand-protein and protein-protein systems is provided. Specifically, the method involves generating a final set of ligand or protein poses based on an initial set of ligand or protein poses. The method considers a variety of tools that can be applied to each pose. Energy scoring of each pose is performed based on results obtained from application of one or more of these tools. The design of the method allows for flexibility in which tools are used, the order in which they are used, and input parameters used for the different tools. This flexibility allows a user of the method to select a level of precision desired for a particular ligand-protein and protein-protein system that is being modified and/or evaluated.

### CROSS REFERENCE TO RELATED APPLICATIONS

The present application is a continuation application of U.S. patent application Ser. No. 12/944,692 filed on Nov. 11, 2010, which in turn, claims priority to U.S. Provisional Application No. 61/260,295, entitled “DarwinDock/GenDock: A New Method to Identify Ligand Binding Sites in Proteins”, filed on Nov. 11, 2009, by William A. Goddard III, Ravinder Abrol, Ismet Caglar Tanrikulu, and Adam R. Griffith, which is incorporated herein by reference in its entirety. The present application can be related to U.S. application Ser. No. 12/142,707, entitled “Methods for Predicting Three-Dimensional Structures for Alpha Helical Membrane Proteins and their use in Design of Selective Ligands”, filed on Jun. 19, 2008, docket number P217-US, by Ravinder Abrol, William A. Goddard III, Adam R. Griffith, and Victor Wai Tak Kam, which is incorporated herein by reference in its entirety. The present application can be related to U.S. application Ser. No. 12/944,700, docket number P701-US, entitled “Methods for Prediction of Binding Poses of a Molecule”, filed on Nov. 11, 2010, by William A. Goddard III, Ravinder Abrol, Ismet Caglar Tanrikulu, and Adam R. Griffith, which is incorporated herein by reference in its entirety.

### FIELD

The present disclosure relates to binding site structure. In particular, it relates to methods for prediction of binding site structure in proteins and/or identification of ligand poses.

### BACKGROUND

Molecular recognition underlies all biological processes through interaction of proteins with other proteins, peptides, or small molecules (also generally called ligands). This molecular recognition process involves changes in conformational degrees of freedom not only for substrates but also for the proteins.

When any two molecules interact, each molecule induces a change in conformation of the other. For instance, when a ligand binds to a protein, a conformational change is induced in both the ligand and the protein. Similarly, when a protein binds to another protein, conformation changes are induced in both proteins. Docking is a method for predicting conformations of one molecule when it binds to another molecule to form a stable configuration.

Evaluation of potential conformations of a particular molecule can depend on, for instance, interaction energy between the two molecules for each potential conformation of the particular molecule.

The evaluation of the potential conformations is generally challenging, especially in terms of computational power and time. The docking process can be used, for instance, in rational drug design, where design of one molecule (generally the drug) is based on knowledge of a target molecule.

### SUMMARY

According to a first aspect of the disclosure, a method for providing a structure of a ligand-protein system or a portion thereof is provided, wherein the ligand-protein system comprises a ligand adapted for binding to a receiving protein, the method comprising performing at least one of: modifying the ligand-protein system or a portion thereof for identifying a structure associated with improved ligand-protein binding; and adjusting precision of energy calculations associated with a structure of the ligand-protein system for identifying binding poses of the ligand and/or the receiving protein associated with a desired energy of the structure. A computer readable medium comprising computer executable software code stored in the computer readable medium can be executed to carry out the method provided in the first aspect of the disclosure.

According to a second aspect of the disclosure, a method for generating a further set of ligand poses based on a set of ligand poses is provided, wherein a ligand is adapted to be bound to a protein to form a ligand-protein system, the method comprising: providing the set of ligand poses; applying one of an optimization tool or an accuracy improvement tool on each ligand pose in the set of ligand poses, wherein the optimization tool alters structure of a binding site of the ligand-protein system and the accuracy improvement tool improves energy calculations of the ligand-protein system; performing energy calculations on each ligand pose in the set of ligand poses; and generating the further set of ligand poses based on the energy calculations from the performing. A computer readable medium comprising computer executable software code stored in the computer readable medium can be executed to carry out the method provided in the second aspect of the disclosure.

According to a third aspect of the disclosure, a method for generating a further set of ligand poses based on a set of ligand poses is provided, wherein a ligand is adapted to be bound to a protein to form a ligand-protein system, the method comprising: providing the set of ligand poses, wherein the ligand is bound to a mutated protein; replacing residues in the mutated protein to form the protein; applying one of an optimization tool or an accuracy improvement tool on each ligand pose in the set of ligand poses, wherein the optimization tool alters structure of a binding site of the ligand-protein system and the accuracy improvement tool improves energy calculations of the ligand-protein system; performing energy calculations on each ligand pose in the set of ligand poses; and generating the further set of ligand poses based on the energy calculations from the performing. A computer readable medium comprising computer executable software code stored in the computer readable medium can be executed to carry out the method provided in the third aspect of the disclosure.

According to a fourth aspect of the disclosure, a method for generating a further set of ligand poses based on a set of ligand poses is provided, wherein a ligand is adapted to be bound to a protein to form a ligand-protein system, the method comprising: providing the set of ligand poses; replacing one or more residues in the protein to form a mutated protein; performing energy calculations on each ligand pose in the set of ligand poses to form an intermediate set of ligand poses; reintroducing the one or more residues in the mutated protein to form the protein; performing energy calculations on each ligand pose in the intermediate set of ligand poses; and generating the further set of ligand poses based on the energy calculations from the performing. A computer readable medium comprising computer executable software code stored in the computer readable medium can be executed to carry out the method provided in the fourth aspect of the disclosure.

According to a fifth aspect of the disclosure, a method for providing a second receiving protein based on a first receiving protein is provided, wherein each ligand pose in a set of ligand poses is adapted for binding to the first receiving protein to form a ligand-protein system, the method comprising: providing the set of ligand poses; applying one of an optimization tool or an accuracy improvement tool on each ligand pose in the set of ligand poses, wherein the optimization tool alters structure of a binding site of the ligand-protein system and the accuracy improvement tool improves energy calculations of the ligand-protein system; performing energy calculations on each ligand pose in the set of ligand poses and the first receiving protein; and adjusting the first receiving protein to obtain the second receiving protein based on the energy calculations from the performing. A computer readable medium comprising computer executable software code stored in the computer readable medium can be executed to carry out the method provided in the fifth aspect of the disclosure.

According to a sixth aspect of the disclosure, a method for providing a second receiving protein based on a first receiving protein is provided, wherein each ligand pose in a set of ligand poses is adapted for binding to the first receiving protein to form a ligand-protein system, the method comprising: providing the set of ligand poses, wherein the ligand is bound to a mutated protein; replacing residues in the mutated protein to form the first receiving protein; applying one of an optimization tool or an accuracy improvement tool on each ligand pose in the set of ligand poses, wherein the optimization tool alters structure of a binding site of the ligand-protein system and the accuracy improvement tool improves energy calculations of the ligand-protein system; performing energy calculations on each ligand pose in the set of ligand poses and the first receiving protein; and adjusting the first receiving protein to obtain the second receiving protein based on the energy calculations from the performing. A computer readable medium comprising computer executable software code stored in the computer readable medium can be executed to carry out the method provided in the sixth aspect of the disclosure.

According to a seventh aspect of the disclosure, a method for providing a second receiving protein based on a first receiving protein is provided, wherein each ligand pose in a set of ligand poses is adapted for binding to the first receiving protein to form a ligand-protein system, the method comprising: providing the set of ligand poses; replacing one or more residues in the protein to form a mutated protein; performing energy calculations on each ligand pose in the set of ligand poses and the mutated protein; replacing the one or more residues in the mutated protein to form the first receiving protein; performing energy calculations on each ligand pose in the set of ligand poses and the first receiving protein; and adjusting the first receiving protein based on the first and second performing. A computer readable medium comprising computer executable software code stored in the computer readable medium can be executed to carry out the method provided in the seventh aspect of the disclosure.

The methods and systems herein described can be used in connection with any applications wherein prediction of a binding site structure and/or of ligand poses is desired.

The methods and systems herein disclosed can therefore have a wide range of applications in fields such as fundamental biological research, microbiology and biochemistry, but also to farm industry and pharmacology. In particular, the methods and systems herein disclosed can be used to design a drug able to bind to a binding site associated with desired biological activities in connection with treatment of a certain condition. The methods herein described can also be used to identify modification of a binding site in connection with a certain ligand.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows an embodiment of a method for selecting a set of ligand poses and optimizing ligand binding poses from an initial set of ligand binding poses.

FIG. 2 illustrates neutralization of charged groups via proton transfer. FIG. 2A illustrates a negatively charged carboxylic acid (proton acceptor) and a positively charged primary amine (proton donor). FIG. 2B illustrates the neutralized forms of a carboxylic acid and a primary amine after neutralization via proton transfer.

FIGS. 3A and 3B show two embodiments of the GenDock method. Specifically, FIG. 3B shows an embodiment of the GenDock method that applies the same tools as shown in FIG. 3A, but applies these tools in a different order.

FIG. 4 shows an embodiment of the GenDock method that applies three optimization tools.

FIGS. 5A and 5B show an embodiment of the GenDock method that involves application of only one tool followed by a scoring and elimination step. FIG. 5C shows an implementation of the GenDock method that involves application of only a scoring and elimination step.

FIG. 6 shows an example of narrowing down of an initial set of ligand poses through application of the tools in the GenDock method.

### DETAILED DESCRIPTION

Methods and systems are described herein for identification of structures and/or poses of molecules following interaction of proteins with other proteins, peptides, or small molecules (also generally called ligands).

The term “protein” as used herein indicates a polypeptide with a particular secondary and tertiary structure that can participate in, but not limited to, interactions with other biomolecules including other proteins, DNA, RNA, lipids, metabolites, hormones, chemokines, and small molecules.

The term “polypeptide” as used herein indicates an organic polymer composed of two or more amino acid monomers and/or analogs thereof. The term “polypeptide” includes amino acid polymers of any length including full length proteins and peptides, as well as analogs and fragments thereof. A polypeptide of three or more amino acids is typically also called a peptide. As used herein the term “amino acid”, “amino acidic monomer”, or “amino acid residue” refers to any of the twenty naturally occurring amino acids including synthetic amino acids with unnatural side chains and including both D an L optical isomers. The term “amino acid analog” refers to an amino acid in which one or more individual atoms have been replaced, either with a different atom, isotope, or with a different functional group but is otherwise identical to its natural amino acid analog.

The term “small molecule” as used herein indicates an organic compound that is of synthetic or biological origin and that, although might include monomers and/or primary metabolites, is not a polymer. In particular, small molecules can comprise molecules that are not protein or nucleic acids, which play a biological role that is endogenous (e.g. inhibition or activation of a target) or exogenous (e.g. cell signaling), which are used as a tool in molecular biology, or which are suitable as drugs in medicine. Small molecules can also have no relationship to natural biological molecules. Typically, small molecules have a molar mass lower than 1 kg·mol⁻¹. Exemplary small molecules include secondary metabolites (such as actinomicyn-D), certain antiviral drugs (such as amantadine and rimantadine), teratogens and carcinogens (such as phorbol 12-myristate 13-acetate), natural products (such as penicillin, morphine and paclitaxel) and additional molecules identifiable by a skilled person upon reading of the present disclosure.

Experimental structures of proteins in apo and holo (ligand-bound) forms provide snapshots frozen in time, so computational studies of a protein-ligand system and an apo-protein in its physiological environment can provide a rationale for physical forces driving the protein-ligand associations. Insights obtained from such computational studies usually have broader ramifications than just the protein-ligand system of interest. For instance, such insights pertaining to any particular protein-ligand system can be generally utilized in other protein-ligand docking systems and specifically to related protein-ligand docking systems. Similar insights can be obtained for protein-protein systems.

Methods are available for predicting ligand binding sites in proteins and poses (also known as conformations) of ligands interacting with the proteins. However, accurate prediction of ligand binding sites is still a daunting challenge. Any method for prediction of ligand binding sites in proteins will have relevance for many biological applications. For instance, some applications (such as therapeutic applications) can involve design of ligands with desired selectivity and specificity.

Ligand bind site prediction methods generally fall into or within two broad areas:
a. Prediction of ligand binding modes in proteins, where accuracy of getting correct contacts with a particular protein is essential.
b. Virtual ligand screening (VLS), which is generally used to find a subset of ligands out of a population of ligands with desired binding for a known protein target. For VLS, accuracy of getting proper contacts with the protein is generally not essential, but speed of the screening is critical.

Prediction methods generally fall within one area or the other. Methods that cover both areas generally are not accurate enough and flexible enough to be applicable to both areas. For instance, many methods that allow for protein flexibility do not provide a standardized implementation to handle protein flexibility. As used in this disclosure, protein flexibility and ligand flexibility refer to physical flexibility of a protein and a ligand, respectively.

The present disclosure presents a broadly applicable method, known as GenDock, that is executed as a computer program aimed at improving a set of docked protein-ligand poses or docked protein-protein poses and accurately selecting the most correct poses from the set. Additionally, the method can be used to obtain information from a set of docked protein-ligand poses or docked protein-protein poses that can be relevant to a number of applications.

Throughout this disclosure, a “pose” (such as a ligand pose or a protein pose) indicates rotational and translational orientations of a molecule relative to another molecule. It takes into account molecular flexibility, which refers to physical flexibility of any particular molecule. Although many poses are possible, some poses are more desirable than others. As will be described later in the disclosure, desirability of a given pose is based on energy scoring between the ligand and the receiving protein.

The GenDock method provides a set of tools for either modifying a protein-ligand binding site (or protein-protein binding site) on a large scale or for fundamentally improving the accuracy with which protein-ligand binding sites (or protein-protein binding sites) can be scored. It should be noted that throughout this disclosure, selection of protein-ligand poses using the tools will be described in detail. Since GenDock addresses both ligand-protein and protein-protein binding, the term “ligand”, as used in this disclosure, refers to both small molecule ligands and proteins. Furthermore, proteins are assumed to include any additional molecules generally associated with a protein system, including but not limited to cholesterols, lipids, metal ions, heme groups, sulfates, phosphates, and so forth. The term “receiving protein” is the protein onto which other molecules, such as ligands, are binding. Consequently, a ligand-protein system comprises a ligand, which can be either a small molecule or a protein, that is bound to a receiving protein.

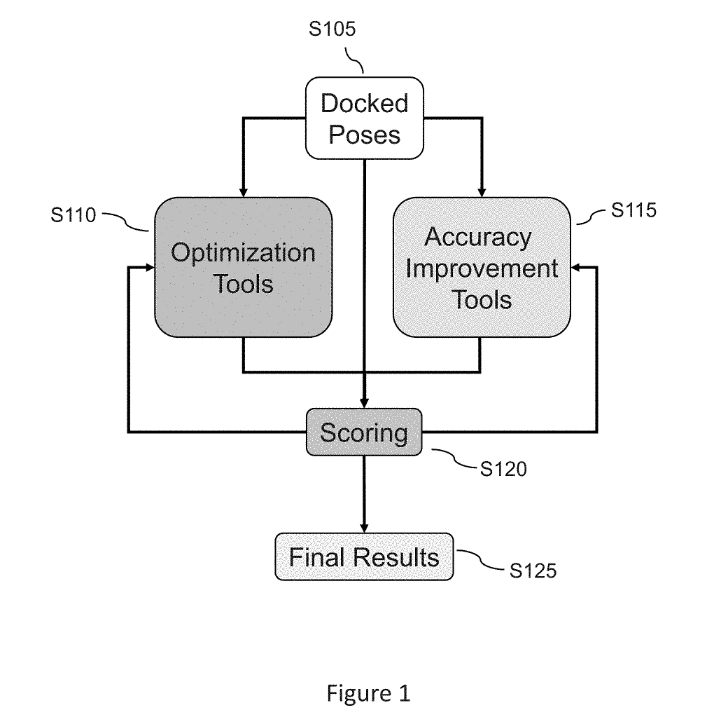

FIG. 1 shows an embodiment of the GenDock method. Given an initial set of docked ligand poses (S105), “Optimization” tools (S110) and/or “Accuracy Improvement” tools (S115) can be applied to the initial set of docked poses to generate a new set of docked poses. The “Optimization” tools (S110) allows for improvement to or modification of the binding site for each docked pose whereas the “Accuracy Improvement” tools (S115) allows for improvement to accuracy of scoring calculations made in evaluating each docked pose.

Specifically, the “Optimization” tools (S110) pertain to modification of the ligand-protein system or any portion of the ligand-protein system in order to identify a structure that is associated with improved ligand-protein binding. Portions of the ligand-protein system include, for instance, a specific ligand pose, a receiving protein, and residues within the receiving protein. Energies associated with the ligand-protein system depend on each of the portions of the ligand-protein system.

A structure with improved ligand-protein binding refers to a structure with lower ligand-protein system energies (such as lower interaction energies and/or lower total energies) than another, less desirable ligand-protein system. Exemplary processes for the “Optimization” (S110) include optimizing binding sites, optimizing specific residues, simulating annealing of the ligand-protein system, and simulating molecular dynamics of the ligand-protein system. Each of these processes will be described in more detail.

The “Accuracy Improvement” tools (S115) pertain to adjusting precision of energy calculations associated with a structure to identify binding poses of the ligand and/or the receiving protein associated with a desired energy of the structure. Specifically, the “Accuracy Improvement” tools (S115) improves accuracy of energy calculations performed on the ligand-protein system and portions of the ligand-protein system. The desired energy of the structure is an energy that is accurate relative to the actual ligand-protein system as found in nature. More accurate calculation of the energies generally leads to more accurate identification of the ligand poses as well as identification of the receiving protein onto which the ligand poses are binding. Exemplary processes for the “Accuracy Improvement” (S115) include neutralizing charges based on charge modification or proton transfer, de-neutralizing charges based on charge modification or proton transfer, minimizing energy of the ligand-protein system, and placing explicit water in the ligand-protein system.

With each application of an “Optimization” tool (S110) or an “Accuracy Improvement” tool (S115), a “Scoring” step (S120) is applied to each docked pose in order to evaluate (through scoring) each docked pose. The “Scoring” step (S120) involves energy scoring, which is the calculating of energies involved in the ligand-protein system and/or portions of the ligand-protein system, and ranking each of the docked poses based on the calculated energies. After application of each tool (S110, S115), docked poses can be (but need not be) eliminated to generate a smaller set of docked poses. Alternative to elimination, docked poses under consideration can instead be re-ranked in terms of desirability with no elimination of any of the docked poses.

Repeated applications of different “Optimization” tools (S110), followed by a “Scoring” step (S120) and/or “Accuracy Improvement” tools (S115) and a “Scoring” step (S120) allow for overall improvement in a protein binding site and accurate selection of ligand poses. For instance, an instance of the GenDock method can include neutralizing of charges based on charge modification (an “Accuracy Improvement” tool) can be performed on charged ligands and/or charged residues, calculating energies of the resulting ligand-protein system, optimizing binding sites of the receiving protein by removing particular residues in the receiving protein (an “Optimization” tool) can be performed, and calculating energies of the resulting ligand-protein system. In each of the calculating steps, certain ligand poses or certain receiving protein structures can be removed from consideration due to undesirable (generally high) energies in the ligand-protein system or portions of the ligand-protein system.

Additionally, it should be noted that applications of additional tools (either “Optimization” or “Accuracy Improvement” tools) can be performed. The tools can be applied in any order, although resulting ligand poses and resulting information of the ligand-protein system can be affected by the order. The same tools can also be applied in succession. For example, three “Optimization” tools, either the same tool or different tools, can be applied to the ligand-protein system. After each application of a tool, a “Scoring” step (and possible elimination step) is performed on the resulting ligand-protein system.

The GenDock method, as shown in FIG. 1, involves application of at least one of an “Optimization” (S110) tool, an “Accuracy Improvement” (S115) tool, or a “Scoring” step (S120). Furthermore, the flexibility of the GenDock method allows a user to tailor use of different tools in different ordering to meet a specified goal. At the conclusion of the GenDock method (S125), the user will have obtained a modified set of docked ligand poses and receiving protein poses. With regards to the protein poses, the user will have obtained information from application of each of the various tools. For instance, an “Optimization” tool (S110) can have generated information that informs the user that, for a given protein-ligand complex, a particular sidechain of the protein is critical to binding of the protein and the ligand and thus should not be mutated in any way (as will be discussed below). Such information can thus be used to determine which receiving proteins and portions (such as binding sites and sidechains) of the receiving proteins are suitable for binding with a particular ligand or set of ligands. It should be noted that, when discussing sidechains and residues, the sidechains and residues are not restricted to the twenty naturally existing amino acids. Instead, non-natural amino acids are also considered sidechains and residues.

The term “scoring” refers to energy-based scoring of one pose relative to another pose, with an assumption that a “better score” translates to a more accurate pose. As will be described later in this disclosure, there are many different ways to obtain an energy-based score for a given ligand pose, and a user of the GenDock method generally makes a decision of which energy-based scoring to use.

The ligand docking or ligand pose input steps (S105) either allow the user to provide a set of ligand poses or to generate a set of ligand poses using a modular wrapper for a given docking program (such as DarwinDock, UCSF DOCK, and Glide). In summary, these ligand poses, whether provided or generated, are then passed to a series of tools that either implement “Optimization” tools (S110) or “Accuracy Improvement” tools (S115), or both. Following each of these modules (S110, S115) is a “Scoring” step (S120), which then passes a next set of poses, not necessarily a reduced set, to a next module in the series. Based on user preferences, the next module can be an “Optimization” tool (S110) or an “Accuracy Improvement” tool (S115). Alternatively, the user can opt to use the next set of poses as the final set of poses. In other words, these next set of poses would serve as the final set of poses output from GenDock.

The GenDock method takes as input a set of ligand poses, where the set of ligand poses can come from a variety of sources. One way of generating this set of ligand poses is to use an external docking program to generate poses using settings suitable for a given system being studied.

Alternatively, modules can be written that serve as wrappers for other docking programs such as DarwinDock, UCSF DOCK, or Glide. Implementing a wrapper for an external docking program simplifies the procedure for the user by combining the pose generation step and the GenDock workup/analysis into a single program call.

The GenDock method takes as input a set of ligand poses and provides as output to the user a better set of ligand poses. One of the ways that GenDock does this is through tools that perform “Optimization” (S110). It should be noted that while the term “optimization” is used, “modification” can also be appropriate. For instance, in sidechain optimization, sidechains in a binding site can be modified (such as through mutations) in order to improve scoring of individual poses.

According to many embodiments of the GenDock method, the “Optimization” tools (S110 in FIG. 1) includes tools for improving the binding site in protein, modifying the binding site (for instance, using mutations), or otherwise generating information with regards to a set of poses.

General categories of the “Optimization” tools (S110) include sidechain optimization/modification and simulated annealing/molecular dynamics. Specific application of each of the different tools, to be detailed below, is determined by the user based on specific goals of the user and/or information desired from analysis of the protein-ligand complex.

It should be noted that SCREAM and SCRWL are programs used for optimizing protein sidechains and/or mutating particular sidechains in the protein. SCREAM and SCRWL can be replaced with other sidechain optimization/replacement programs. Further, it is noted that molecular mechanics/dynamics package such as MPSim and LAMMPS can be used to perform calculations such as minimization, simulated annealing, molecular dynamics, and energy scoring.

Sidechain optimization can be used in a variety of capacities for a variety of purposes. Sidechain optimization tools include, but are not limited to, binding site optimization, optimization of specific residues, alanization, dealanization, and mutation. Sidechain optimizations are generally performed using such programs as SCREAM and SCRWL. However, other sidechain optimization/modification programs can also be used.

Binding site optimization is generally used to improve positioning of sidechains within the binding site. Such modifications generally involve improved interactions between the protein and the ligand. Binding site optimization can involve modifying a binding site in a protein by modifying positioning between the protein sidechains and the ligand from a sub-optimal positioning to a more desirable positioning. A more desirable positioning can be identified, for instance, by improved hydrogen bonding between the protein and the ligand (as well as within residues of the binding site), improved Coulomb interactions, and improved van der Waals interactions, each of which lead to better scoring energy. The better scoring energy signifies that the binding site is more likely to be a binding site within which the ligand would bind with the protein.

In binding site optimization, scope of the binding site can be adjusted. For instance, distance constraints with respect to positioning of the ligand and the binding site, types of residues included in the protein, and so forth, can each re-define or more particularly define the binding site. New portions, such as new sidechains, can be added to the protein. Structural aspects of the protein can also be adjusted in binding site optimization. For instance, loops can be added in helices that are already present in the protein.

Optimization of specific residues allows improvement of specific portions of the binding site, as opposed to optimization of the entirety of the binding site. This allows a user to improve the binding site at a more precise level. In other words, rather than attempting to optimize the entire binding site, it can be helpful to optimize specific residues. For instance, particular residues that are known to be important to protein-ligand binding, perhaps determined through experimental data, can suggest that the particular residues must not be modified in any way. In contrast, particular residues that are known to be unimportant can be removed from the protein entirely, since the particular residues add complexity (such as computational complexity) to the protein-ligand system but do not significantly affect the protein-ligand binding. Such experimental data can be obtained, for instance, through prior protein-ligand docking experiments (such as those performed by GenDock).

Alanization is a sidechain modification procedure that allows the user to replace a set of residues (typically large, non-polar residues) with alanines (or other, generally small, residues). The purpose of alanization is generally to allow focus on the non-alanized residues, which are generally polar residues since polar residues are the residues that typically anchor the ligand to the protein. However, the residues being replaced need not be large, non-polar residues. For instance, from prior experimental data, it can be determined that tryptophan (a large, non-polar residue) is critical to protein-ligand binding and thus should not be alanized. In certain cases, residues on which alanization is performed can be modified by the user. SCREAM and SCRWL are examples of programs that can perform this sidechain modification procedure, although other sidechain optimization programs can also be used. Adjustable parameters can include, but is not limited to, which residue types to alanize, specific residues to alanize, specific residues to not alanize, and what residue type or types to change to. As previously mentioned, the replaced residues are generally replaced with alanine; however, other residues can also be used.

Dealanization is the opposite procedure relative to alanization. In particular, dealanization “restores” or replaces the alanized sidechain with the original sidechain residues. Dealanization can also involve restoring the original sidechain at its original coordinates (prior to the alanization).

Mutation can be applied to specific residues within the binding site. A “wild-type” protein is the dominant form of a protein in the general population. However, there are often significant populations of a protein, similar and related to the “wild-type” protein, with a specific mutation that can result, among other things, in different efficacy and activity between the mutant form of the protein and the ligand. Adjustable parameters can include, but is not limited to, which residues to mutate and which residue types to mutate to, as well as parameters found in other sidechain optimization programs such as SCREAM and SCRWL.

In one example, given experimental mutation data on a protein-ligand system, appropriate mutations to residues within the binding site can be performed in order to determine which poses most accurately correspond to the experimental data. In another example, mutation of specific residues within the binding site can be used to determine the most important residues for binding between the protein and the ligand and thus can be used to propose targets for study by experimentalists. In yet another example, mutation of specific residues in the binding site can be used to study the differences in ligand binding between wild-type and mutant forms of a particular protein.

Simulated annealing/molecular dynamics are tools that can be used to either produce large changes within the binding site or to obtain relevant data about the binding site. In simulated annealing, temperatures of the protein-ligand system are changed constantly in an attempt to bring the protein-ligand system into different energy levels. Such a procedure allows evaluation of stability of the binding site, where a higher stability signifies that the particular ligand pose is more likely to be the actual pose in the protein-ligand system. As an example, simulated annealing is often used to allow a ligand to traverse energy barriers and potentially find a more globally optimal position within the binding site.

Molecular dynamics could be used to assess the stability of a ligand within the binding site. Molecular dynamics calculations are commonly performed at a steady temperature for an adjustable length of time, whereas simulated annealing calculations are performed over cycles of temperature increase and decrease also for an adjustable length of time. The scope of these calculations can be varied, ranging from just the ligand on the small end, the entire binding site, or the entire protein on the large end. By way of example and not of limitation, adjustable parameters can include number of annealing cycles, length of annealing cycles, temperature profile for annealing, molecular dynamics temperature, and length of molecular dynamics calculation.

It should be noted that in addition to generating a second set of ligand poses based on a first set of ligand poses, the GenDock method can also be utilized to generate an adjusted receiving protein based on a first receiving protein. Specifically, each of the “Optimization” tools (S110 in FIG. 1) introduces modifications to the receiving protein. For instance, alanization replaces certain residues in the receiving protein with alanines (or other, generally small, residues) while binding site optimization affects positions of sidechains in the receiving proteins. These adjustments are generally used to yield more desirable (based on energy scoring) ligand-protein systems. By extension, information based on these adjustments can be used in generating an adjusted receiving protein that yields more desirable ligand-protein systems.

In contrast to the “Optimization” tools (S110) presented above, “Accuracy Improvement” tools (S115) attempt to improve ability to score poses by modifying the protein-ligand systems at a more fundamental level. Methods for improving and addressing fundamental errors in the scoring calculations, as provided by each of the “Accuracy Improvement” tools (S115), include charge modification, energy minimization, and explicit water placement.

Charge modification via neutralization. Charge modification can involve neutralization of charges. Coulomb's law dictates that large charges can have a correspondingly large effect in molecular mechanics calculations. This effect is often unnaturally large because molecular mechanics/dynamics calculations are only approximations of the physical system and thus does not generally include proper dampening of such interactions, where the proper dampening would occur in an actual physical system. Long-range Coulomb interactions can allow small changes in the position of charged atoms to have a large impact on scoring of the binding site. In order to reduce the impact of Coulomb interactions, neutralization of charged residues and charged ligands in the system can be used.

Proton transfer and charge manipulation can be used to perform such neutralizations. In proton transfer, protons are moved from positively charged donors to negatively charged acceptors, resulting in neutral residues and ligands. Programs such as SCREAM or SCRWL can also be used to perform a variation of the proton transfer method. In charge manipulation, charges on the atoms of a charged residue or ligand are simply rescaled so that they sum to be zero. For example, each atom is typically assigned a partial charge so that the sum of the partial charges for a residue is an integer value (aspartic acid would have a sum of −1, alanine would have a sum of 0, and arginine would have a sum of +1). The partial charges of the atoms in charged residues could be scaled linearly so that, instead of summing to +1 or −1, they would sum to zero.

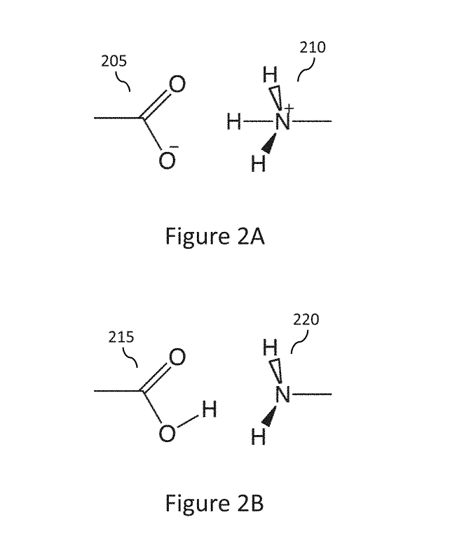

Charge modification via reapplication of charges. Charge modification can also be performed through reapplication of charges. There can be situations where a user would temporarily wish to restore charges to appropriate residues or ligands. One such situation can occur when simulated annealing is performed following neutralization via proton transfer. FIG. 2A shows a charged carboxylic acid group (205) interacting with a charged primary amine (210). FIG. 2B shows how the groups (205, 210 in FIG. 2A) have been neutralized via proton transfer. In the charged example, one of the two oxygen atoms can interact with any of the three hydrogen atoms. Potential hydrogen bonding partners in the neutral case (shown in FIG. 2B) are generally more limited. This causes the neutral case to be less stable during dynamics or annealing, signifying that interaction between the two groups (215, 220 in FIG. 2B) is generally more likely to break.

Energy Minimization. The “Accuracy Improvement” tools (S115) can also involve energy minimization. Energy minimization is a tool in molecular mechanics that decreases energy of a system as well as typically reducing forces within that system. By minimizing the energy of a set of ligand poses to a specified RMS force threshold, a more direct comparison of energies of the poses can be performed. Within the scope of GenDock, energy minimization can be performed on the ligand, the binding site, the entire protein-ligand complex, or any other relevant portion of the complex. The purpose of energy minimizations is to reduce the stresses/forces within the system. These forces are sometimes increased by application of other tools and it is necessary to reduce them in order to obtain accurate scoring energies. The molecular mechanics programs used for such minimizations have a large number of adjustable parameters, including but not limited to: the type of minimization calculation being used (for instance, conjugate gradient minimization), the type of force-field being used, the number of steps of minimization, force threshold cutoffs, as well as other parameters, some of which depend specifically on the program and method used.

Explicit Water Placement. The “Accuracy Improvement” tools (S115) can also involve explicit water placement. Docked protein-ligand systems found in nature generally occur in the presence of water and other molecules (such as lipids and cholesterols). However, it is often not computationally reasonable to include the entire environment in which the system would occur. In particular, energy calculations on the poses are typically performed as vacuum calculations, occasionally with the addition of implicit solvation to correct for the lack of explicit waters in the system. These implicit solvation methods are approximations and thus can be inaccurate. Furthermore, these implicit salvation methods can also be time-consuming. By placing explicit waters (or ions, such as sodium or chlorine) in the protein-ligand system, the explicit waters interact with the ligand and/or with important protein sidechains and thus can be replaced or be used in conjunction with implicit solvation during the energy calculation.

As with the “Optimization” tools (S110 in FIG. 1), each of the “Accuracy Improvement” tools (S115 in FIG. 1) also affects the ligand-protein system and portions of the ligand-protein system. As mentioned previously, portions of the ligand-protein system include, for instance, a specific ligand pose, a receiving protein, and residues within the receiving protein. Since energy scoring is performed on one or more components of the ligand-protein system, the “Accuracy Improvement” tools (S115 in FIG. 1), which directly improves results of the energy scoring, also affects the components of the ligand-protein system. Specifically, results of the energy scoring have an effect on the desirability of a specific ligand pose and of a particular structure of the receiving protein. Consequently, the “Accuracy Improvement” tools (S115 in FIG. 1), similar to the “Optimization” tools (S110 in FIG. 1), also provides information pertaining to both the ligand as well as the receiving protein.

With reference back to FIG. 1, subsequent to application of any “Optimization” tool (S110) and the “Accuracy Improvements” tool (S115), the “Scoring” step (S120) is performed. As previously mentioned, the “Scoring” step (S120) involves evaluation of a particular set of poses based on results of application of a tool (S110 or S115) and possibly elimination of lower scoring poses. Elimination of poses is not required. For instance, the scoring can be used to rank each pose in the set of poses without necessarily eliminating any poses from consideration. Several different scoring energies can be applied in evaluating ligand poses after an “Optimization” tool (S110) or an “Accuracy Improvement” tool (S115) has been applied. These energies are used to select which poses are passed to the next tool. The user typically specifies how many poses are kept either through a percentage of total poses, a specific number of poses, or some combination of both, although some energy types can be used as filters that keep poses that meet certain criteria, such as interaction with a specific residue in the binding site.

It should be noted that, in addition to generating a final set of ligand poses from an initial set of ligand poses input into the GenDock method, information pertaining to the ligand-protein system and portions of the ligand-protein system. Specifically, the final set of ligand poses can be a result of adjusting aspects of one or more of a particular ligand pose and the receiving protein. For instance, information pertaining to which residues in the receiving protein to replace (an “Optimization” tool) and which charges in the ligand and/or receiving protein to neutralize (an “Accuracy Improvement” tool) can be utilized to identify more desirable ligand-protein systems and portions of the ligand-protein system. The “Scoring” step (S120) is affected by both the “Optimization” tools, which introduce changes to one or both of the ligand and the receiving protein, and the “Accuracy Improvement” tools, which affect accuracy of energy scoring performed on the ligand-protein system and portions of the ligand-protein system.

By way of example and not of limitation, several scoring energies are shown in the following, non-exhaustive list. For purposes of this listing, “C” refers to the complex, “P” refers to the protein, “L” refers to the ligand, “Ref” refers to a reference ligand, “vac” refers to the vacuum energy, and “solv” refers to the implicit solvation energy.
Total energy—Total vacuum energy of the complex (protein and ligand).
Interaction energy—Total vacuum energy of the ligand and the nonbond energy between the ligand and the protein. Polar interaction energy is a polar energy component of the interaction energy. Phobic interaction energy is a hydrophobic energy component of the interaction energy.
Unified or local cavity analysis—Vacuum nonbond energy between the ligand and the residues in a unified or local cavity. It should be noted that a cavity is generally defined as the binding site itself or residues within the binding site. The local cavity is defined as all residues within a specified distance (e.g. 5 Å) of the ligand for a given pose. The unified cavity is the set of all residues in any of the local cavities for a set of poses. Consider the following example. Pose A has a local cavity of residues 1, 2, and 3. Pose B has a local cavity of residues 1, 2, and 4. Pose C has a local cavity of residues 2, 3, and 5. The unified cavity would be residues 1-5 for each ligand pose.
Hydrogen cavity analysis for a set of residues—Hydrogen bonding component of the cavity analysis only for the specified set of residues. This energy is typically used as a filter so that only poses with energy greater than a given threshold are kept.
Full cavity analysis for a set of residues—The full cavity analysis only for the specified set of residues. This energy is typically used as a filter so that only poses with energy greater than a given threshold are kept.
Snap binding energy—C_{vac}−P_{vac}−L_{vac}
Snap binding energy with ligand solvation—C_{vac}−P_{vac}−(L_{vac}+Lₛₒₗᵥ)
Snap binding energy with full solvation—(C_{vac}+Cₛₒₗᵥ)−(P_{vac}+Pₛₒₗᵥ)−(L_{vac}+Lₛₒₗᵥ)
Snap binding energy with ligand strain—C_{vac}−P_{vac}−L_{vac}+(L_{vac}−Ref_{vac})
Snap binding energy with solvation and ligand strain—(C_{vac}+C ₛₒₗᵥ)−(P_{vac}+Pₛₒₗᵥ)−(L_{vac}+Lₛₒₗᵥ)+[(L_{vac}+Lₛₒₗᵥ)−(Ref_{vac}+Refₛₒₗᵥ)]
Average Total/Unified Cavity Rank—Rank all poses by both total and unified cavity and average those rankings.

$$Average Rank = \frac{( Total Energy Rank ) + ( Unified Cavity Rank )}{2}$$

Aside from the cavity analyses provided above, analysis of the ligand poses can also involve ligand clustering and visualization. Ligand clustering can be performed on a current set of poses to determine how similar the ligand poses are to each other. Ligand poses that are sufficiently geometrically similar can be clustered into a family. This information can be used as a reference for the user, or it can possibly be incorporated into the “Scoring” (S120 in FIG. 1) step so that only a certain number of poses from each family are kept.

A visualization of the ligand poses can play a role in each of the steps in GenDock. There are numerous visualization programs for viewing molecules, some of which, such as PyMol or VMD, allow for simple scripting to automate visualization. A module can be implemented that can use such scripting to easily visualize the output.

It should be noted that tools run within GenDock need not be run exclusively of each other. For instance, “binding site sidechain optimization” and “dealanization of specific residue types” can be performed at the same time.

One important factor in identifying realistic coordinates for a ligand bound to a target protein is having an accurate way to score the interaction energy between the ligand poses and the target protein and assign each ligand-protein pose a measure of success. The measure of success is used for determining which poses are better or more accurate. Generally, in a ligand-protein system, success refers to being able to reproduce a ligand position observed in ligand-protein co-crystals. A co-crystal contains real world coordinates for components within the ligand-protein system.

An all-atom molecular mechanics force-field (such as DREIDING 3) is used to determine extent of interaction between the ligand pose and the target protein. However, in order for a force-field like DREIDING to provide a realistic energy score on each pose, the atomistic model of the target protein associated with the molecular pose should be accurate. Obtaining this accuracy, however, is generally a challenge. The bound conformations of the ligand and the protein are tightly linked, and when the ligand conformation is unknown, it is generally difficult to generate an atomistically accurate model of the protein landscape. For instance, it is difficult to obtain accurate coordinates for sidechains in the protein positioned to interact with a given ligand pose.

Errors in models used in scoring make it difficult to correctly identify interactions between the ligand pose and the target protein. Among these errors, errors due to polar interactions, such as Coulombic and hydrogen-bonding interactions, generally act as main determinants of specificity in molecular recognition. Because magnitude of polar interactions has strong dependences on relative orientation and distance between polar groups on the ligand and the target protein, small errors in pose placement can be detrimental to the energy score of the ligand and the target protein. This is in contrast to van der Waals interactions, which roughly measure surface contact and are usually not significantly affected by errors in pose placement.

Considering importance of correct identification of polar interactions between the ligand and the target protein, alanization, the method generally used to remove bulky hydrophobic sidechains from the target protein, is used to allow better sampling of polar groups on the target protein by ligand poses. In some cases, exposing polar groups on the target protein through alanization and scoring ligand poses using only polar components of the interaction energy (known as polar energy, which is the sum of Coulombic and hydrogen-bonding components) worked well for ligands rich in hydrogen-bond donors and acceptors.

However, the method of using alanization proves to be inconsistent when used on largely hydrophobic ligands. In this case, switching the scoring energy from polar to hydrophobic (known as phobic energy, which quantifies van der Waals component of the interaction energy) drastically improves quality of the search results, despite the absence of hydrophobic sidechains on a model of the target protein. A scoring scheme can be chosen based on nature of the ligand. This scheme generally involves human intervention.

A hybrid scoring method can be utilized that involve less or no user intervention. In this case, top poses are determined independently using three different energy schemes: polar, phobic and total energy scores. Total energy is the sum of all DREIDING energy components and includes polar and phobic components.

With reference back to FIG. 1, successive cycles of applying “Optimization” tools (S110), “Accuracy Improvement” tools (S115), “Scoring” steps (S120), and possibly elimination steps serve to identify ligand poses that are more likely to be correct while eliminating those more likely to be incorrect. Once each combination of a tool (S110 or S115) with scoring (S120) (and possibly elimination) has been completed, the user is left with an enhanced set of poses containing more accurate results.

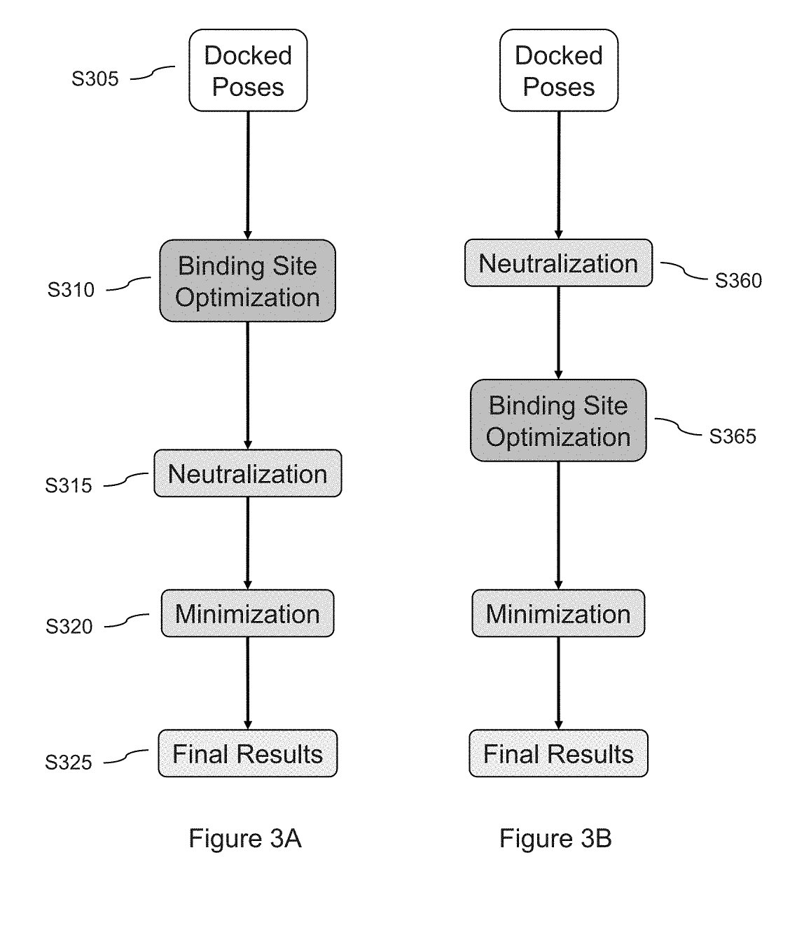

FIGS. 3A and 3B show two embodiments of the GenDock method. Specifically, FIG. 3A shows an embodiment of GenDock that comprises, in order, steps of providing an initial set of ligand poses (S305), applying a binding site optimization tool (S310), applying a neutralization tool (S315), applying a minimization tool (S320), and providing as output a final set of ligand poses (S325). FIG. 3B shows an embodiment of GenDock that comprises the same steps, but applies the tools in a different order. Specifically, application of a neutralization tool (S360) occurs prior to application of a binding site optimization tool (S365) in FIG. 3B, whereas the order is switched in FIG. 3A. Both FIGS. 3A and 3B involve one “Optimization” tool (the binding site optimization) and two “Accuracy Improvement” tools (the neutralization and minimization). Although not explicitly shown in either FIG. 3A or 3B, a step of scoring (and possibly eliminating) ligand poses occurs after application of each of the tools. Also, as previously noted, final results of GenDock include a final set of ligand poses as well as information that can be obtained concerning the protein-ligand system.

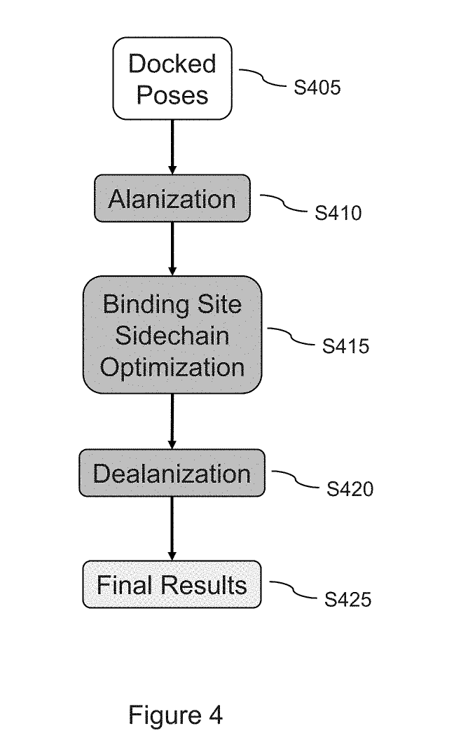

FIG. 4 shows an embodiment of the GenDock method that applies three “Optimization” tools. The embodiment comprises steps of providing an initial set of ligand poses (S405), applying an alanization tool (S410), applying a binding site sidechain optimization tool (S415), applying a dealanization tool (S420), and providing as output a final set of ligand poses (S425).

An example implementation of the embodiment shown in FIG. 4 is given as follows. The alanization tool (S410) can involve, for instance, replacing bulky, non-polar residues (such as valine, leucine, isoleucine, phenylalanine, tyrosine, tryptophan, and methionine) in the binding site with alanine. The alanization tool (S410) generates a mutated protein, or more specifically an alanized protein. Following application of the alanization tool (S410), scoring of the ligand-alanized protein system is performed to rank each of the ligand poses. Elimination need not be performed to generate a smaller set of ligand poses.

With continued reference to the specific example, the binding site sidechain optimization tool (S415) can then be applied to optimize remaining (in this case, polar) residues in the binding site. With the bulky, non-polar residues alanized, the polar residues have better access to the ligand as well as better access to other polar residues in the binding site, both accesses that allow for better hydrogen bond and Coulombic interactions between the ligand and the (alanized) protein. A scoring and possibly eliminating step then follows application of the alanization tool (S415).

As a last tool in this particular embodiment of the GenDock method, the dealanization tool (S420) is applied to remove the effects of the alanization tool (S410). Specifically, the previously removed bulky, non-polar residues (in this case given as valine, leucine, isoleucine, phenylalanine, tyrosine, tryptophan, and methionine) are placed back into the binding site using a sidechain optimization tool such as SCREAM and SCRWL. The dealanization tool (S420), in addition to reintroducing the previously removed residues, can also optimize orientation of the sidechains with respect to the ligand and the polar residues in the binding site. A scoring and possibly eliminating step then follows application of the dealanization tool (S420).

Since the dealanization tool (S420) is the last tool utilized in the embodiment of FIG. 4, results of the scoring and possible elimination after application of the dealanization tool (S420) are the final results generated by this embodiment of the GenDock method. Specifically, the final results include a final set of ligand poses as well as any information that has been obtained from utilization of each of the tools (S410, S415, S420) throughout the GenDock method. As previously mentioned, the information can be utilized in future docking experiments. As an example, the information for a particular ligand-protein system can yield that tryptophan is critical to the binding of the ligand and the protein. In such a case, it can be preferable in future experiments on the same or similar ligand-protein systems to not alanize the tryptophan despite it generally being a bulky, non-polar residue.

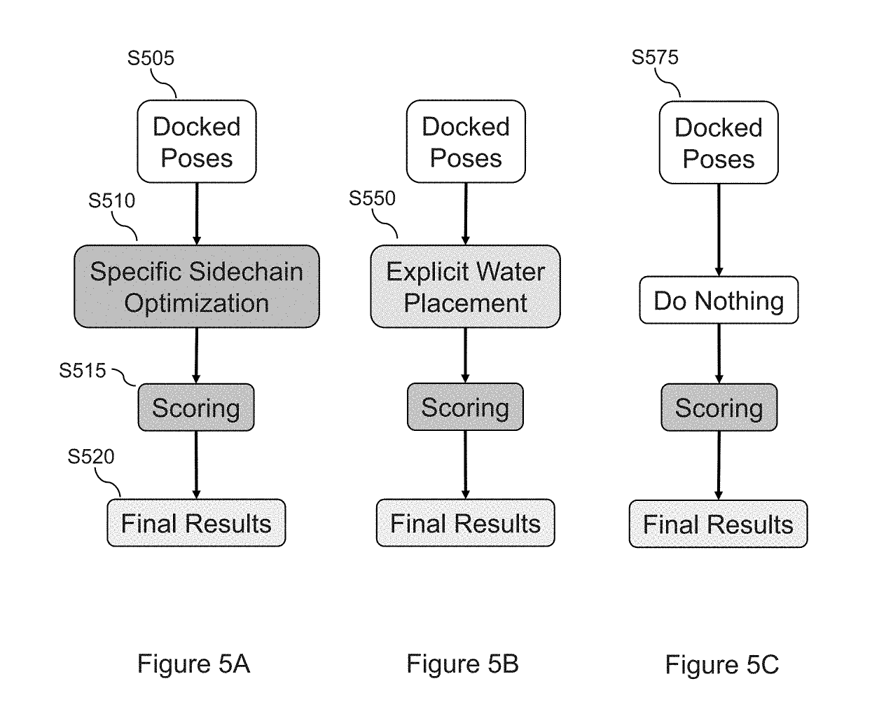

FIGS. 5A and 5B show an embodiment of the GenDock method that involves application of only one tool followed by a scoring and elimination step. FIG. 5A shows an embodiment of GenDock that comprises, in order, steps of providing an initial set of ligand poses (S505), applying a specific sidechain optimization tool (S510), scoring and possibly eliminating ligand poses (S515), and providing as output a final set of ligand poses (S520). FIG. 5B replaces application of the specific sidechain optimization tool (S510) with an explicit water placement tool (S525). In both FIGS. 5A and 5B, only one tool (an “Optimization” tool for FIG. 5A and an “Accuracy Improvement” tool for FIG. 5B) are utilized in the GenDock method.

FIG. 5C shows an implementation of the GenDock method that involves application of only a scoring and elimination step. Such an implementation can stand alone. In other words, an initial set of ligand poses can be provided (S575), and, without modifying any of the ligand poses, a scoring of the ligand poses can be utilized to rank each of the ligand poses and possibly eliminate certain ligand poses from consideration. The implementation in FIG. 5C can also be applied to a set of ligand poses generated by, for instance, the embodiment shown in FIG. 5B. The implementation in FIG. 5C can take the resulting set of ligand poses generated from the embodiment in FIG. 5B and, without modifying the poses, re-score the ligand poses using a different scoring energy, The scoring can be used to re-rank the ligand poses, and the ranking can (but need not) be used to eliminate certain ligand poses from consideration.

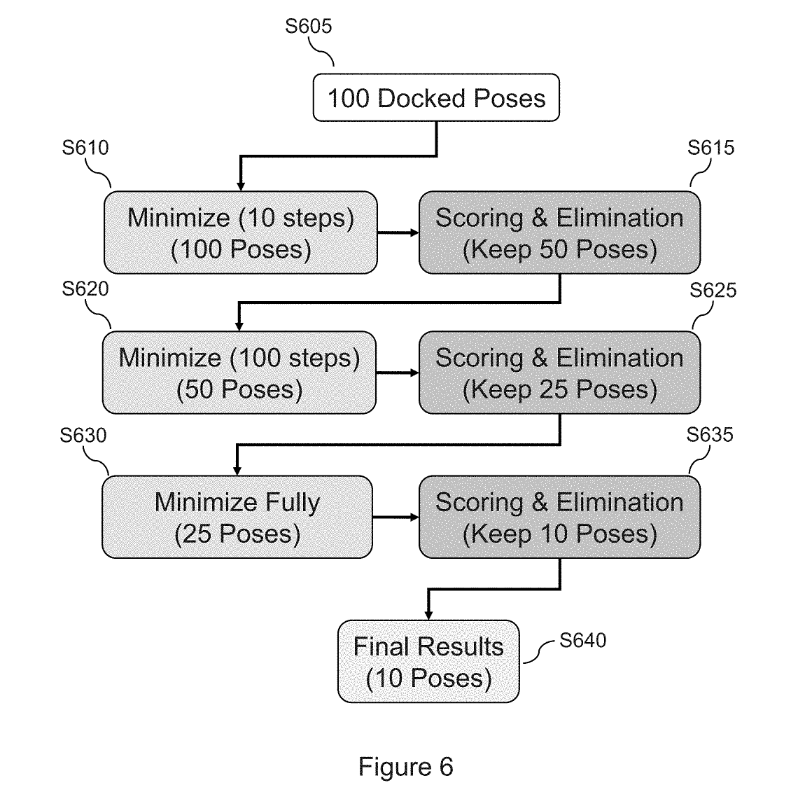

FIG. 6 shows an example of narrowing down of an initial set of ligand poses through application of the tools in the GenDock method utilizing a single tool numerous times. A user might have, provided as input to the GenDock method, an initial set of 100 ligand poses (S605). A minimization tool involving 10 steps of minimization (S610) can be applied to these 100 poses. At this stage, since there is a larger number of poses, short minimizations are generally used to reduce computational time. A first scoring step (S615) is then utilized to rank each of the ligand poses and eliminate the bottom 50 scoring ligand poses. Consequently, only 50 ligand poses remain after this first scoring step (S615). A minimization tool involving 100 steps of minimization (S620) can be applied to these 50 poses. Since there is now a few number of ligand poses, longer minimizations are generally utilized to improve accuracy of the scoring results. A second scoring step (S625) is then utilized to rank each of the ligand poses and eliminate the bottom 25 scoring ligand poses. For the remaining 25 ligand poses, a minimization tool that minimizes to a desired threshold (S630) is applied. With even fewer ligand poses on which to perform minimization, the minimization at this stage is generally selected to be more accurate. A final scoring and elimination step (S635) is then performed on the remaining ligand poses and a final set of 10 ligand poses is output (S640) to the user of the GenDock method. It should be noted that the numbers above specifically that of starting from an initial set of 100 ligand poses and narrowing down to 50, 25, and finally 10 ligand poses are arbitrary. The number of ligand poses in a given set is generally defined by the user.

As another example (not explicitly shown), the user might have an initial set of 200 ligand poses as an input to the GenDock method that need to be narrowed down into a smaller, more accurate set of poses. These 200 poses could be passed to a binding site optimization step with half being eliminated after scoring. The remaining 100 poses could be passed to an “Accuracy Improvement” tool (S115 in FIG. 1) with a further elimination of half after re-scoring. The remaining 50 poses could then be passed to a different type of “Accuracy Improvement” tool (S115 in FIG. 1), with only 5 poses being kept after re-scoring. The user has now narrowed the set of 200 poses to a more accurate and manageable set of 5 poses which can then be subjected to further analysis and use by the user.

In each of FIG. 3A through FIG. 6, a result of the GenDock method is a final set of ligand poses, where the final set of ligand poses is generally smaller in number of ligand poses than an initial set of ligand poses that served as input to the GenDock method. However, it should be reiterated that, additionally, the GenDock method also provides information on the ligand-protein system and portions of the ligand-protein system. This information can be used, for instance, in determining how to modify a particular ligand and/or a particular receiving protein in order to improve binding in the resulting ligand-protein system.

In the case of ligand-protein systems, it should be noted that a set of ligand poses can be supplied to the GenDock method by way of the DarwinDock method (see Appendix 1, which forms an integral part of the present disclosure). The DarwinDock method also involves use of a clustering algorithm (see Appendix 2, which forms an integral part of the present disclosure). The set of ligand poses generated by DarwinDock is based on the following procedure. DarwinDock comprises a “Completeness” step and a “Selection” step. Initial generation of the ligand poses themselves can be performed outside of DarwinDock using another program such as Dock6. A general description of Dock6 can be found at the html page which can be found at the http site dock.compbio.ucsf.edu/index. The resulting set of ligand poses from the “Selection” step of DarwinDock can then be used as the starting point for GenDock.

The modules of the GenDock method can be written in any of the primary programming languages, such as Perl, Python, C, Java, Fortran, etc., and can be implemented to run on both individual PCs and multi-node clusters. The executable steps according to the methods and algorithms of the disclosure can be stored on a medium, a computer, or on a computer readable medium. The various steps can be performed in multiple processor mode or single-processor mode. All programs should be able to run with minimal modification on most individual PCs.

Implementations of the GenDock method can involve molecular mechanics/dynamics packages for energy calculations, energy minimizations, simulated annealing, and molecular dynamics. Examples of such packages are MPSim and LAMMPS. Implementation of the sidechain optimization/modification modules can involve access to a program for performing those adjustments, examples of which are SCREAM and SCRWL. Various other helper programs can be necessary for file conversions, structure analysis, data parsing, etc.

The examples set forth above are provided to give those of ordinary skill in the art a complete disclosure and description of how to make and use the embodiments of the methods for prediction of binding site structure in proteins and identification of ligand poses of the disclosure, and are not intended to limit the scope of what the inventors regard as their disclosure. Modifications of the above-described modes for carrying out the disclosure can be used by persons of skill in the art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### LIST OF REFERENCES

[1] Bray J K and Goddard W A (2008). The structure of human serotonin 2c G-protein-coupled receptor bound to agonists and antagonists. J. Mol. Graph. Model. 27, 66-81.
[2] Cho A, et al. (2005). The MPSim-Dock Hierarchical Docking Algorithm: Application to the eight trypsin Inhibitor co-crystals. J. Comp. Chem., 26, 48-71.
[3] Fanelli F and De Benedetti PG (2005). Computational Modeling Approaches to Structure-Function Analysis of G-Protein-Coupled Receptors. Chem. Rev. 105, 3297-3351.
[4] Floriano, W. B., Vaidehi, N., Singer, M., Shepherd, G., Goddard III, W. A. (2000) Molecular mechanisms underlying differential odor responses of a mouse olfactory receptor, Proc. Natl Acad. Sci U.S.A. 97, 10712-10716.
[5] Freddolino P L, et al. (2004). Structure and function prediction for human □2-adrenergic receptor. Proc. Natl. Acad. Sci. USA, 101, 2736-2741.
[6] Goddard W A and Abrol R (2007). 3D Structures of G-Protein Coupled Receptors and Binding Sites of Agonists and Antagonists. Journal of Nutrition 137, 1528S-1538S.
[7] Huang, Shoichet, and Irwin, (2006). Benchmarking sets for molecular docking. J. Med. Chem. 49, 6789-6801.
[8] Kalani M Y, et al. (2004). Three-dimensional structure of the human D2 dopamine receptor and the binding site and binding affinities for agonists and antagonists. Proc. Natl. Acad. Sci. USA, 101, 3815-3820.
[9] Kam V W T and Goddard W A (2008). Flat-Bottom Strategy for Improved Accuracy in Protein Side-Chain Placements. J. Chem. Theory Comput. 4, 2160-2169.
[10] Li Y Y, Zhu F Q, Vaidehi N, and Goddard W A (2007). Prediction of the 3D Structure and Dynamics of Human DP G-Protein Coupled Receptor Bound to an Agonist and an Antagonist. J. Am. Chem. Soc. 129, 10720-10731.
[11] Mayo, S. L., Olafson, B. D. Goddard III, W. A. (1990) DREIDING—a generic force field for molecular simulations. J. Phys. Chem. 94, 8897-8909.
[12] Moustakas D T, et al. (2006). Development and validation of a modular, extensible docking program: DOCK 5. J. Comput. Aided Mol. Design 20, 601-609.
[13] Peng J Y P, et al. (2006). The Predicted 3D Structures of the Human M1 Muscarinic Acetylcholine Receptor with Agonist or Antagonist Bound. Chem Med Chem 1, 878-890.
[14] Rocchia W, et al. (2001). Extending the applicability of the nonlinear Poisson-Boltzmann equation: Multiple dielectric constants and multivalent ions. J. Phys. Chem. B 105, 6507-6514.
[15] Vaidehi N, et al. (2002). Structure and Function of GPCRs. Proc. Natl. Acad. Sci., USA 99, 12622-12627.
[16] Vaidehi N, et al. (2006). Predictions of CCR1 chemokine receptor structure and BX 471 antagonist binding followed by experimental validation. J. Biol. Chem. 281, 27613-27620.
[17] Warren G L, et al. (2006). A critical assessment of docking programs and scoring functions. J. Med. Chem. 49, 5912-5931.

### APPENDIX 1

The DarwinDock method comprises a “Completeness” step and a “Selection” step. Initial generation of the ligand poses themselves can be generated outside of DarwinDock using another program such as Dock6.

In the “Completeness” step, DarwinDock uses the input ligand poses, generally generated by another program, and a receiving protein to generate a population of ligand binding poses large enough to cover the search space at a desired convergence level

In an initial round of the “Completeness” step, a user-defined number of ligand poses, referred to as the step-size (SS), is generated using the sphere regions defined over the receiving protein. A second step involves using a clustering algorithm, such as that described in Appendix 2. Families are formed based on position of ligand poses in the receiving protein. The clustering algorithm distributes the starting set of ligand poses into families, where a family is a group of ligand poses in the population of ligand poses that show similar positions (also known as orientations) with respect to the receiving protein.

In a second round of the “Completeness” step, an additional SS molecular poses is generated to reach 2×SS number of ligand poses, and the clustering of the ligand poses into families is repeated. The population of molecular poses in the second round contains all SS poses generated in the first round as well as SS new poses. During the clustering in the second round, if a new pose is found to be similar in its placement in the receiving protein to a pose carried over from the first round, the new pose is grouped together with the previously existing pose in the same family. However, if a new pose is distinct from all previously existing poses in the population of ligand poses, the new pose is placed into a new family. As described in Appendix 2, the clustering into families is based on RMSD (root mean square difference) calculations between any two molecular poses. Specifically, distance between two molecular poses is calculated by averaging deviation of the two poses over all heavy (non-hydrogen) atoms. Hydrogen atoms are generally not taken into account because their location depends on location of other atoms and thus hydrogen atoms contribute little to an RMSD calculation.

The number of families that can successfully represent a given search space will depend on the size and shape of the search space and varies greatly with each ligand-protein pair. Therefore, an absolute number of exclusively-new families will be indicative of different levels of coverage in different systems. Using a ratio of exclusively-new family count to total number of families provides a metric of completeness that is system-independent.

Starting with the second round of the “Completeness” step, the DarwinDock method monitors percentage of exclusively-new families introduced over all families, which is referred to as % ENF in FIG. 1. In each successive round, an additional SS poses are introduced into the population, resulting population is clustered, and % ENF is calculated. When the % ENF drops below a user-defined threshold of completeness, ligand pose generation is halted, and the search space coverage is declared complete. Although it is possible to continue this process until no exclusively-new families are generated (% ENF=0%), % ENF of 2% or 5% are commonly used as the completeness threshold in DarwinDock runs due to computational and time constraints.

The “Selection” step for the binding poses uses interaction energy between a particular ligand pose and the receiving protein as a metric for identifying the best families and poses within the best families. For each of the families, a family head is selected. The family head is one member of each family that best geometrically represents the members of the family. Specifically, the family head, also referred to as a centroid pose, is one of the poses closest in RMSD (and thus geometrically closest) to all the other poses in the family.

In a first step of the “Selection” step, the best families are determined by ranking them according to an energy score based on interaction energy determined for each of the family heads. Specifically, the families are ranked based on the interaction energy between the family head and the receiving protein. Top families are identified as the families with the best scoring family heads, where best scoring refers to lowest energy. In many cases, top 10% (a user-defined percentage) of the families are retained for a second step of the “Selection” step.

A variety of scoring energies that can be used in selecting top poses. Each of the scoring energies depends on interaction energy between the ligand and the receiving protein. Scoring energies can be a function of total interaction energy, which is a sum of vaccum energy of the first molecule and nonbond energy between the first molecule and the target molecule; polar interaction energy, which is the polar component of the total interaction energy; and phobic interaction energy, which is the hydrophobic component of the total interaction energy. Nonbond energy refers to the sum of Coulomb, van der Waals, and hydrogen-bond energies.

In the second step of the “Selection” step, all members of the selected top families are scored and ranked. Top poses, which are those molecular poses that best interact (have lowest interaction energy) with the target molecule among the top families, are then selected and reported as outputs of the DarwinDock method. Number of poses output by the DarwinDock method is user-defined.

Accuracy of the “Selection” step depends heavily on assignment of representative family heads and accuracy of the energy scoring. A poorly assigned family head can cause an otherwise successful set of molecular poses to be excluded from the set of top families, and thereby can reduce accuracy of a final set of molecular poses output by DarwinDock. This issue becomes significant when geometric size (the physical volume taken up by poses in a family) of families becomes large, making it difficult to come up with a single family head that can be representative of the whole family.

Due to these factors, a clustering algorithm (see Appendix 2) can be used to provide tight families in a fast manner instead of focusing on achieving mathematically well-defined families. A tight family is one where all members are within a small threshold RMSD, also referred to as a diversity level. An exemplary range of diversity levels is between 1.0 and 2.4 Å RMSD. An RMSD of 2.0 Å is generally a good compromise between speed and accuracy.

### APPENDIX 2

The clustering scheme that has been implemented as part of DarwinDock takes as an input a set of ligand poses, clusters them into families using a diversity parameter, and assigns a family head. The diversity parameter provides a threshold RMSD, wherein all members of a family are within the threshold RMSD. The diversity parameter determines tightness of a family, which in turn determines whether a particular member of the family can be the family head. A default value for the diversity parameter is 2 Å. However, this value can be changed based on physical interactions between the ligand poses and the receiving protein.

The specific steps of the clustering step are as follows:
1. Calculate full RMSD matrix for all ligand conformations using heavy atoms (non-hydrogen).
2. Keep all RMSD matrix elements (r_{i,j}) less than or equal to the diversity parameter and sort the matrix elements in increasing order. Subscripts i and j refer to two different ligand poses.
3. Lowest matrix element r_{i,j} automatically places ligand poses i and j into the same family.
4. Starting with the next higher RMSD element r_{k,l}, one of three scenarios can arise:
   a. Pose k is part of an existing family and l is not part of an existing family. Thus, in order for pose l to become part of the family with pose k, pose l needs to have its RMSD value relative to all members of that family less than the diversity parameter. Since RMSD is defined between two poses, an RMSD of a relative to all members in a family needs to be smaller than or equal to the diversity parameter.
   b. Pose k is part of an existing family and l is part of another family. In order for the two families to merge and become one family, RMSD values across all poses in the two families need to be less than the diversity parameter.
   c. Pose k and pose l are not part of any families, and hence poses k and l start a new family.
This is done until all RMSD elements are exhausted.
5. A family head is assigned to each family as one which is the geometric center of that family in the RMSD space. A family with two members has the family head as one with the lowest interaction energy with the target protein.

1.-53. (canceled)

54. A computerized system for generating a second set of ligand poses based on a first set of ligand poses, wherein a ligand is adapted to be bound to a receiving protein to form a ligand-protein system, wherein the computerized system comprises:
a docking module configured to provide an initial set of ligand poses;
an optimization tool configured to perform a modification on the ligand-protein system or a portion thereof for identifying a structure associated with improved ligand-protein binding on each ligand pose in an input set of ligand poses, wherein the performing alters a structure of and optimizes a binding site of the ligand-protein system and results in a modified set of ligand poses;
an accuracy tool configured to perform a modification on the ligand-protein system or a portion thereof for identifying a structure associated with improved ligand-protein binding on each ligand pose in an input set of ligand poses, wherein the performing improves energy calculations of the ligand-protein system and results in a modified set of ligand poses; and
a scoring module configured to compute energy calculations on each ligand pose modified by said optimization tool and/or accuracy tool in an input set of ligand poses and the receiving protein and rank the input set of ligand poses accordingly, producing a ranked set of ligand poses;
wherein the computerized system is configured to allow a user to implement the optimization tool and the accuracy tool in any order and any number of times, from a previous tool to a next tool, such that
the scoring module is used after the previous tool and
the ranked set of ligand poses from the scoring module is the input set of ligand poses for the next tool, the next tool being either the same or different than the previous tool.

55. The system of claim 54, wherein the optimization tool is selected from the group consisting of:
optimizing binding sites, wherein the optimizing binding sites comprises at least one of adding an additional residue or residues to the protein, modifying structural aspects of the protein, and modifying positions of one or more residues within the protein,
optimizing specific residues, wherein the optimizing specific residues comprises replacing the one or more residues within the protein with a different set of more residues,
applying simulated annealing of the ligand-protein system for each ligand pose in the set of ligand poses, and
applying molecular dynamics of the ligand-protein system for each ligand pose in the set of ligand poses.

56. The system of claim 54, wherein the accuracy improvement tool is selected from the group consisting of:
neutralizing charges based on charge modification or proton transfer,
de-neutralizing charges based on charge modification or proton transfer,
minimizing energy of the ligand-protein system, and
placing explicit water in the ligand-protein system.

57. The system of claim 54, wherein the scoring module computes energy calculations based on force-field based energies of the ligand-protein system.

58. The system of claim 57, wherein the force-field based energies comprise at least one of:
total energy of the ligand-protein system,
interaction energy between the ligand and the receiving protein,
cavity analysis of a portion or an entirety of the ligand-protein system,
snap binding energy of the ligand and the receiving protein separately, and
snap binding energy of the ligand-protein system.

59. The system of claim 58, wherein the cavity analysis is selected from the group consisting of unified cavity analysis, local cavity analysis, hydrogen cavity analysis for a set of residues, and full cavity analysis for the set of residues.

60. A computerized method for generating a second set of ligand poses based on a first set of ligand poses with the computerized system of claim 54, wherein a ligand is adapted to be bound to a receiving protein to form a ligand-protein system, the method comprising:
optimizing ligand poses by using the optimization tool, the optimization tool configured for modifying the ligand-protein system or a portion thereof for identifying a structure associated with improved ligand-protein binding on each ligand pose in an input set of ligand poses, wherein the modifying alters a structure of and optimizes a binding site of the ligand-protein system;
improving accuracy of ligand poses by using the accuracy tool, the accuracy tool configured for modifying the ligand-protein system or a portion thereof for identifying a structure associated with improved ligand-protein binding on each ligand pose in an input set of ligand poses, wherein the modifying improves energy calculations of the ligand-protein system; and
scoring ligand poses with the scoring module, the scoring comprising energy scoring optimized ligand poses and/or ligand poses with an improved accuracy and ranking each ligand pose accordingly, producing a ranked set of ligand poses;
wherein the optimizing ligand poses and the improving accuracy of ligand poses are performed in any order and any number of times, from previous tool to next tool, such that the scoring step is performed after using each tool, and the ranked set of ligand poses from the scoring step is the input set of ligand poses for the next tool, the next tool being the same or different from the previous tool.

61. The method of claim 60, further comprising:
replacing one or more residues in the receiving protein to form a mutated protein;
conducting energy calculations on each ligand pose in a set of ligand poses and the mutated protein to modify that set of ligand poses; and
reintroducing the one or more residues in the mutated protein to form the receiving protein;
wherein the one or more residues in the replacing and the reintroducing are user-defined.

62. The method of claim 61, wherein the replacing comprises performing alanization on the receiving protein to form the mutated protein and the reintroducing comprises performing dealanization on the mutated protein to form the receiving protein.

63. The method of claim 61, wherein the one or more residues selected are based on polarity and size of each of the one or more residues.

64. The method of claim 61, wherein the one or more residues are selected from the group consisting of phenylalanine, isoleucine, leucine, methionine, tyrosine, valine, and tryptophan.

65. The method of claim 60, wherein the method begins with the performing the scoring step.

66. The method of claim 60, wherein the method begins with the using the optimization tool.

67. The method of claim 60, wherein the method begins with the using the accuracy tool.
